(19) United States
(12) Patent Application Publication
(10) Pub. No.: US 2023/0356384 A1
(43) Pub. Date: Nov. 9, 2023

(54) HANDLE ELEMENT FOR RECEIVING A HANDLE OF A HANDLE TOOL AND HANDLE FOR OR WITH A HANDLE TOOL

(71) Applicant: Juergen STOLL, Weilheim/Teck (DE)

(72) Inventor: Juergen STOLL, Weilheim/Teck (DE)

(21) Appl. No.: 18/143,157

(22) Filed: May 4, 2023

(30) Foreign Application Priority Data
May 5, 2022 (DE) 10 2022 111 124.5
Aug. 23, 2022 (DE) 10 2022 121 254.8

(51) Int. Cl. B25G 1/10

(52) U.S. Cl. CPC B25G 1/102

(57) ABSTRACT

A handle element for receiving a handle of a manageable handle tool, includes an adapter element for at least partially receiving the handle and at least one gripping surface as well as a handle for or with a handle tool. The handle element has a front region V through the region facing the handle tool, a middle region M and a rear region H, and a first gripping surface and a second gripping surface are provided. Both gripping surfaces are oriented differently with respect to the handle or handle tool, such that forces can be applied differently to the handle tool by gripping around a gripping surface.

### CROSS REFERENCE TO RELATED APPLICATIONS

Applicant claims priority under 35 U.S.C. § 119 of German Application No. 2022 111 124.5 filed May 5, 2022, and German Application No. 10 2022 121 254.8 filed Aug. 23, 2022, the disclosures of which are incorporated by reference.

### DESCRIPTION

The invention relates to a handle element for receiving a handle of a manageable handle tool, comprising an adapter element for at least partially receiving the handle and at least one gripping surface, as well as a handle for or handle with a handle tool and such a handle element.

### STATE OF THE ART

From U.S. Pat. No. 5,606,772 A a universal primary handle for use with tools and utensils is known. The tools and utensils suitable for this purpose have a handle which generally has a round cross-section and is designed in such a way that it can be grasped with one hand. The primary handle can be placed on a handle of a tool, for example a broom handle, and can be embraced by the hand in different ways, making the handle ergonomically usable. In combination with a secondary cross-handle, a tool or utensil can be very easy and comfortable to use. The primary handle device has a handle that slides over or is subsequently frictionally connected to the end of the handle of a tool or utensil. The handle has a multiple angled surface comparable to a handrail, in which the primary hand can assume a substantially straight angular position (180° angle) with respect to the wrist axis. The correct hand position varies depending on the tool and the work surface. The proper grip angle for a particular task allows the hand to maintain a straight angle with respect to the wrist axis while transmitting the driving force of the arm to the shank of the tool. The handle is arc-shaped and extends in its longitudinal direction in the direction of the handle to be picked up.

DE 201 15 631 U1 describes a handle that can be mounted on a shaft. By means of a clamping device, a non-positive connection can be made between the handle and a shaft. In the mounted position on the handle, the curved handle extends transversely to the longitudinal extension of the handle.

From DE 10 2010 014 807 A1 an additional handle for a handle tool is known. The handle is designed for various handle tools and is intended to provide stability when mounted. The auxiliary grill is intended to support the use of handle tools. This is because ergonomic work with handle tools is difficult for users to sustain, especially with irregular use. Likewise, a certain amount of musculature is necessary. The additional handle is attached to the tool by means of a mounting bracket. This is formed by a wooden cylinder, which is closed on one side and open on the other. The longitudinal axis of the handle is perpendicular to the longitudinal axis of the wooden cylinder. The axis of the handle is perpendicular to the longitudinal axis of the wooden cylinder. There are two longitudinal slots in the wooden cylinder. The stem can be fixed by a mounting clamp and a mounting nut and piston. The mounting nut is attached to the open longitudinal end of the wooden cylinder. This allows the stem to be pressed against the closed end of the wooden cylinder.

Handle tools, such as shovels, are widely used tools worldwide. However, the handle at the end of the shovel leads to a poor force effect. This results in a risk of injury to the lower back. Here, US 2011/0173778 A1 describes a handle device consisting of three main components, namely a fastening device, a grip device and a base piece. The arcuate handle is to be positioned longitudinally or transversely to the longitudinal direction of the handle tool, depending on the application.

### DISADVANTAGES OF THE STATE OF THE ART

The known devices must have a long handle in order to use the known hand grip elements. Long means that the tool can be used while standing, it can be held with both hands (ambidextrous, i.e., with the left and right hands of one person), and that the tool is active far away from the hand, for example, on the ground by the movement of the handle. Small handle tools, such as files, rasps, saws, scraper blades or even scrapers and brushes are not applicable.

A main characteristic of short-handled handle tools is that they are preferably operated with one hand compared to long-handled tools. Short-handled therefore means all length dimensions of handles that can still be operated with one hand. A preferred maximum length is 1 m. Long-handled tools are normally operated with both hands. The front hand applies pressure to the surface and the back hand “controls” the tool. In the case of short-handled tools, all force actions must therefore be performed with one hand. For this purpose, the handle tool is picked up and operated with the stronger hand. With conventional handle tools, this means that the pressure on the tool has to be generated by twisting the wrist and/or applying strong pressure with the thumb. This leads to rapid fatigue of the user and often also to unsatisfactory results, since the various force effects cannot be applied by the user with the operating hand over a longer period of time.

In order to exert the appropriate pressure on the handle tool, it is necessary for the wrist to be bent from its relaxed rest position. This leads to extreme strains on the corresponding muscles as well as stresses on the joints, ligaments and also the muscles.

Another disadvantage is that it is not possible to simply change a handle element for different handle tools. This is because different handle tools have different handling characteristics and are also gripped differently by the user, depending on which handle tool is used for which activity.

### TASK OF THE INVENTION

Therefore, it is the task of the invention to eliminate at least one of the mentioned disadvantages.

### Task Solution

The solution of the task is given by the features of one aspect of the invention.

### Advantages of the Invention

In the design of the handgrip element or the handle according to the invention, the wrist assumes a natural approx. 180 degree position relative to the arm. If possible, this position should be at least approximately maintained by gripping around the handle element, regardless of the angular position that the handle encloses between itself and the ground.

To achieve this, the handle element has different grip positions. This enables virtually fatigue-free operation of the tool, as the pressure is not transmitted to the handle tool via the wrist or thumb, but by the much stronger operating arm. This leads to less fatigue with better work results.

In particular, the wrist is not angled at all or only slightly, which means that the forces applied by the muscles are transmitted directly to the hand via the joint with little or no loss of force. Due to the special shape of the handle element and the articulation of the handle, it is possible to use the handle element according to the invention for different handle tools.

The handle element is shaped in side view such that this has at least one gripping surface at least approximately perpendicular and a further gripping surface, for example approximately parallel to the imaginary extension of the handle of the handle tool. A gripping surface is at least as large as a hand, so that the latter can be gripped around at least partially. Preferably, however, the gripping surface is so large that different gripping positions can be adopted on a gripping surface. This also means that the gripping surfaces can be operated with gloves.

The grip position on the respective grip surface that the user assumes depends on the respective activity with the handle tool. Furthermore, the grip position depends on the inclination of the handle between itself and the flat surface, for example the floor. Due to the different design of the two grip surfaces, the user therefore has a variety of possible grip positions to work fatigue-free and powerfully as well as efficiently.

An adapter area is provided to accommodate handles of handle tools, but also adapters of handle tools. The handle can be accommodated in different directions.

Another advantage of the invention is that the developed handle element can be used either as an additional adapter element for a handle tool or in such a way that the handle element is an integral part of the handle tool. This means that tool, handle and handle element are one component. A preferred example is a scraper or an ice scraper, which preferably have such a handle element as an integral part of the handle tool. This means that the handle and handle element are formed as one piece.

Further advantageous embodiments are shown in the following description, the claims and the drawings.

### DRAWINGS

The drawings show:

FIG. 1 shows a perspective view of a first embodiment of a handgrip element;

FIG. 2 shows a side view of the handle element according to FIG. 1;

FIG. 3 shows a view of an application of the handle element according to FIGS. 1 and 2;

FIGS. 4 [A] to 4 [E] show various schematic representations of other embodiments of a handgrip element;

FIG. 5 shows a schematic side view of a further embodiment of the handle element, wherein the handle element is formed integrally with the stem; and

FIG. 6 shows a view of a further embodiment.

### DESCRIPTION OF AN EMBODIMENT

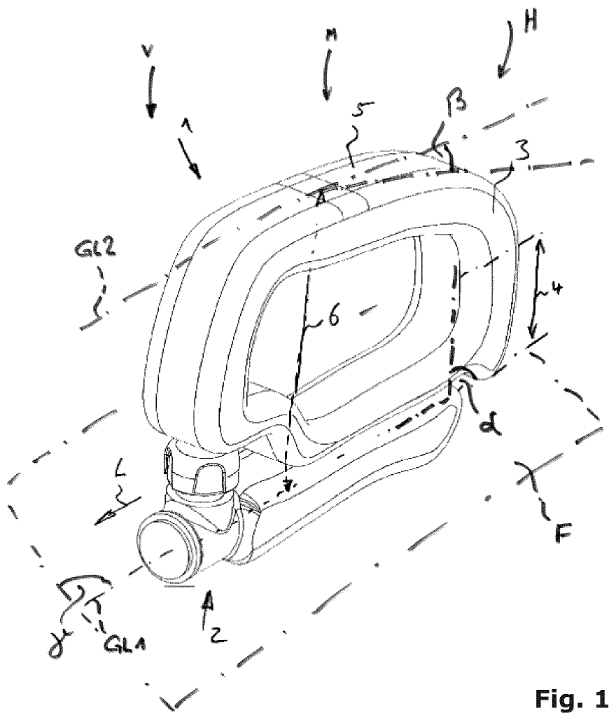

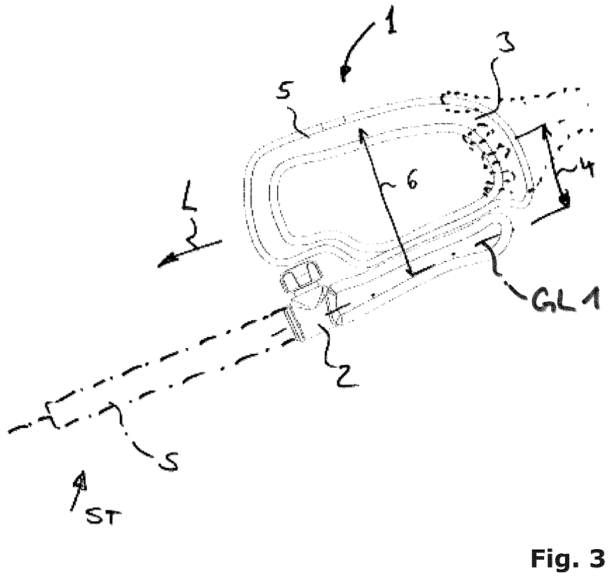

FIGS. 1 and 3 and FIG. 6 show a handle element 1. This has an adapter element 2 for receiving a handle S of a handle tool ST. In the embodiment example shown in FIGS. 1 to 3 and 6, the adapter element 2 is designed in such a way that it can receive the handle S in the longitudinal extension L of the handle element 1. For ease of illustration and description, the position of the handle is indicated in each case by the dashed line GL1 and GL2. The handgrip element 1 has a front region V, a middle region M and a rear region H, the front region V being the region facing towards the tool operated by the handle. The rear area H is the area that is close to the person being operated.

The hand grip element 1 has a first grip surface 3 that extends at an angle alpha to the longitudinal extent of the hand grip element 1 (represented by the dashed line GL1). This angle alpha is 90 degrees. Depending on the embodiment, it may also be smaller than 90 degrees. An angle of 90 degrees means that the first grip surface 3 in the rear region H extends perpendicularly away from the imaginary longitudinal extension (line GL1). Less than 90 degrees means that the end of the first gripping surface 3 extending away from the imaginary longitudinal extension is arranged opposite to the front area V, i.e. further into the rear area H.

This first gripping surface 3 is important for proper and force-optimized use, particularly in the longitudinal direction L, since the force applied here is applied at a distance 4 from the imaginary extension of the handle S. Due to this first gripping surface 3, the user has the possibility to transmit the force to the hand grip element 1 in a wrist position that is better for the transmission of force. In addition, the offset application of force in relation to the handle S or handle tool ST creates a moment and thus considerably increases the force applied to the handle tool ST compared to the previous embodiment.

To ensure further good handling, a second gripping surface 5 is provided in the embodiment example shown in FIGS. 1-3. This second gripping surface 5 is arranged at a distance 6 from the imaginary extension of the handle S. This second gripping surface 5 is arranged at an angle beta to the longitudinal extension of the hand grip element 1 (represented by the dashed line GL2). The angle beta may be greater than 0 or less than 0. Greater than 0 means that the gripping surface 5 is spaced further apart from the handle in the front region V than in the rear region H in relation to the longitudinal extent of the handle. Less than 0 means that the gripping surface 5 is spaced shorter apart from the handle in the front region V than in the rear region H in relation to the longitudinal extent of the handle.

Depending on the angular position, shown in FIG. 1 by the angle gamma, to the working surface F, the user can grip around the first gripping surface 3 or the second gripping surface 5 at a gripping position. Since a variety of grip positions are possible on a gripping surface 3, 5, the position with the least fatigue for the time of use can be selected by trial and error. This allows further pressure and force build-up in the area of the ST handle tool.

The gripping surfaces 3, 5 are designed in such a way that they can be grasped by a user's hand, either with or without gloves. Preferably, the gripping surfaces 3, 5 are ergonomically designed and are adapted to the palms of the hands. Further embodiments provide that there is a special design that enables non-slip gripping around. The gripping surfaces 3, 5 are preferably designed in such a way that different gripping positions can be achieved on one gripping surface. This allows the user to determine the appropriate position by trial and error.

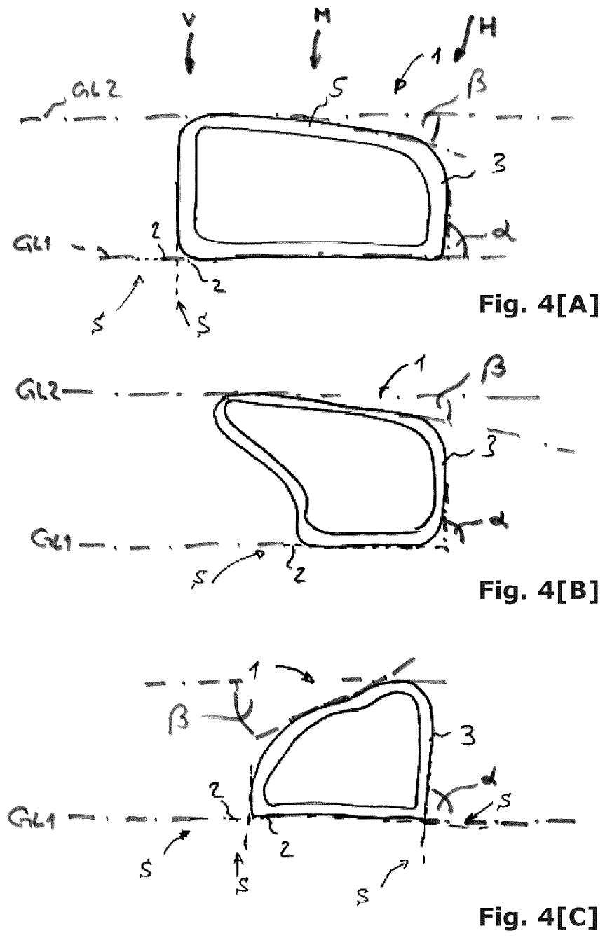

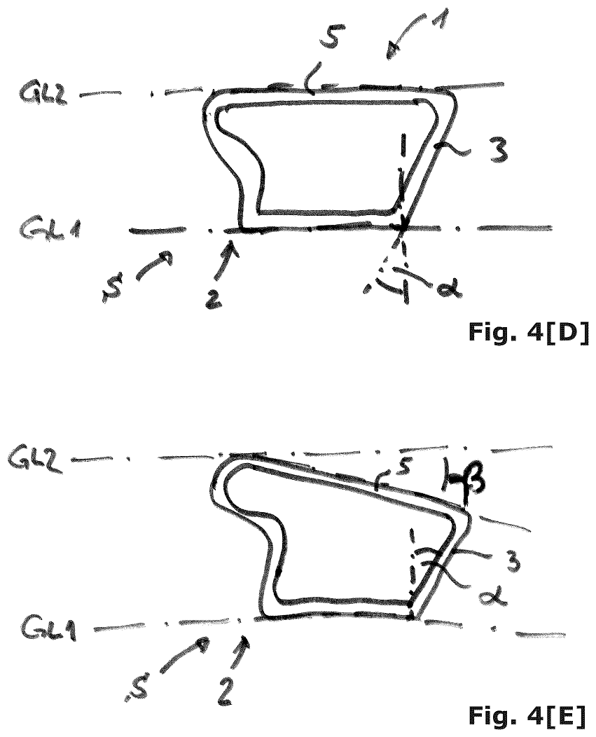

Different handle types are shown in FIGS. 4 [A] to 4 [E]. What they have in common is that they have a first grip surface 3, as described previously. The remaining design of the handle element 1 is free and can have a further second gripping surface 5, as shown in FIG. 4 [A]. In the drawings, the adaptive pick-up options are shown by stylized representations of the handle S, where the respective representations differ from the position of the gripping surfaces 3, 5 to the longitudinal extension (represented by the dashed line GL1 and GL2) by different angles alpha and beta. All designs have an adapter 2. This adapter makes it possible to accommodate a handle or a tool.

According to FIG. 4 [B], the first grip surface 3 is perpendicular and thus the angle alpha is 90 degrees to the longitudinal extension of the handle element 1 (imaginary dashed line GL1). The second grip surface 5 is not parallel and thus the angle beta is greater than 0 degrees to the longitudinal extension of the handle element 1 (imaginary dashed line GL2).

According to FIG. 4 [B], the first grip surface 3 is perpendicular and thus the angle alpha is 90 degrees to the longitudinal extension of the handle element 1 (imaginary dashed line GL1). The second grip surface 5 is inclined and thus the angle beta is greater than 0 degrees to the longitudinal extension of the handle element 1 (imaginary dashed line GL2). This means that the second grip surface 5 rises in the direction of the adapter 2.

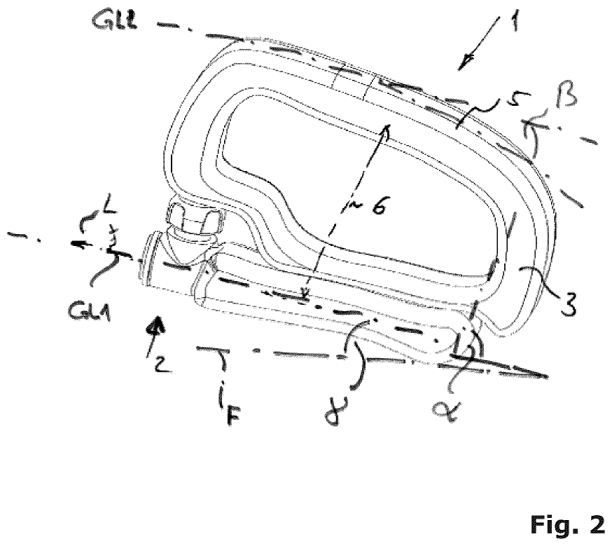

The design according to FIGS. 4 [A] to 4 [B] serves especially for low-fatigue work when powerful work is to be carried out with the tool at an angle gamma (FIG. 2).

According to FIG. 4 [C], the first grip surface 3 is perpendicular and thus the angle alpha is 90 degrees to the longitudinal extension of the handle element 1 (imaginary dashed line GL1). The second grip surface 5 is not parallel and thus the angle beta is not equal to 0 degrees to the longitudinal extension of the handle element 1 (imaginary dashed line GL2). In contrast to FIG. 4 [A], the angle is negative. Negative means that the second grip surface 5 slopes towards the adapter, whereas it rises in the versions according to FIGS. 4 [A] to 4 [B].

According to FIG. 4 [D], the first grip surface 3 is not perpendicular and thus the angle alpha is less than 90 degrees to the longitudinal extension of the handle element 1 (imaginary dashed line GL1). The second grip surface 5 is parallel and thus the angle beta is 0 degrees to the longitudinal extension of the handle element 1 (imaginary dashed line GL2).

According to FIG. 4 [E] represents a combination of the embodiments according to FIGS. 4 [A], 4 [B], and 4 [D]. In this embodiment, the first grip surface 3 is not perpendicular and thus the angle alpha is smaller than 90 degrees to the longitudinal extension of the hand grip element 1 (imaginary dashed line GL1). The second grip surface 5 is not parallel and thus the angle beta is greater than 0 degrees to the longitudinal extension of the handle element 1 (imaginary dashed line GL2).

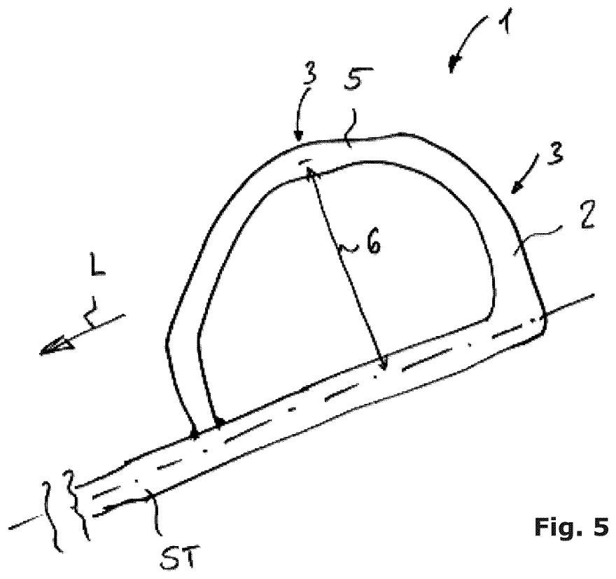

FIG. 5 shows a further embodiment of a handle element 1, since in this embodiment it is an integral part of the stem ST. The handle ST has, at its free end, a handle tool which is not shown in more detail in the drawings and to which a stem ST is connected. The handle ST is shaped in such a way that a gripping surface 3 extends away from it at the free end, which then—in side view in D-shape—changes into a parallel extension (at a distance) to the handle ST and here forms a further gripping surface 3. Such a depicted tool can be, for example, an ice scraper for scraping frozen car windows.

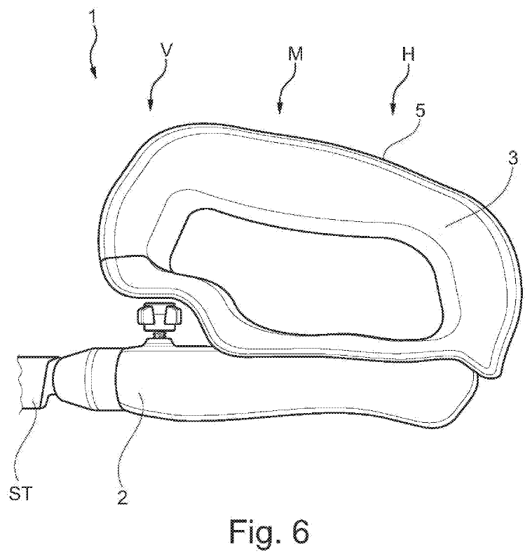

FIG. 6 shows another embodiment of the handle element 1. It also shows the adapter element 2 for receiving a stem element ST shown in partial representation.

### LIST OF REFERENCE NUMBERS

1 Handle element
2 Adapter element
3 First grip surface
4 Distance
Second grip surface
6 Distance
L Longitudinal extension
S Handle
ST Handle tool
GL1 Line
GL2 Line
V Front area
M Middle area
H Rear area
F Working surface

1. A handle element for receiving a handle of a handle tool which can be handled, having an adapter element for at least partially receiving the handle and at least one gripping surface, wherein the handle element (1) has a front region V through the region facing the handle tool, a middle region M and a rear region H, and a first gripping surface (3) and a second gripping surface (5) are provided, wherein
a. the first gripping surface is arranged in the rear region H of the handgrip element (1) and extends away from the imaginary extension (GL1) of the handle ST at an angle alpha less than or equal to 90 degrees, and
b. the second gripping surface (5) is arranged in the front region V, in the middle region M and in the rear region H of the handle element and extends at a distance (6) from the handle ST, such that the distance of the second gripping surface (5) in the front region (V) to the imaginary extension (GL1) of the handle ST is greater than this distance (6) in the rear region H of the handle element (1), so that the longitudinal extension of the second gripping surface (5) assumes an angle beta to the imaginary extension GL2 and the angle beta is greater than 0 degrees.

2. The handle element according to claim 1, wherein the first grip surface (3) and the second grip surface (5) are formed in one piece.

3. The handle according to claim 1, wherein the first gripping surface (3) and the second gripping surface (5) and the handle ST are formed integrally.

4. The handle according to claim 1, wherein the first gripping surface (3) and the second gripping surface (5) and the handle ST are formed integrally together with the handle tool.
